(19) United States
(12) Patent Application Publication
(10) Pub. No.: US 2024/0402814 A1
(43) Pub. Date: Dec. 5, 2024

(54) ENHANCED TACTILE INFORMATION DELIVERY SYSTEM

(71) Applicants: SENSIBALL VR ARGE ANONIM SIRKETI, Tepebasi/Eskisehir (TR); KARMALAB ARGE BILISIM YAZILIM SANAYI VE TICARET LIMITED SIRKETI, Tepebasi/Eskisehir (TR)

(72) Inventors: Ugur KAFADAR, Eskisehir (TR); Umut SENTURK, Eskisehir (TR)

(73) Assignees: SENSIBALL VR ARGE ANONIM SIRKETI, Tepebasi/Eskisehir (TR); KARMALAB ARGE BILISIM YAZILIM SANAYI VE TICARET LIMITED SIRKETI, Tepebasi/Eskisehir (TR)

(21) Appl. No.: 18/697,060

(22) PCT Filed: Sep. 30, 2021
(86) PCT No.: PCT/TR2021/050995

§ 371 Date: Mar. 29, 2024

(51) Int. Cl. G06F 3/01; A61H 19/00; A63B 71/06; G06F 3/0346

(52) U.S. Cl. CPC G06F 3/016; A61H 19/00; A63B 71/0619; G06F 3/014; A63B 2071/0655; G06F 3/015; G06F 3/0346

(57) ABSTRACT

An enhanced tactile information delivery system for artificial/virtual reality applications of physical activities comprises at least one processor, one data retention means, preferably a virtual activity apparatus, and at least one multiple mechanical stimulation unit comprising at least one mechanical simulator preferably positioned on certain predetermined locations on user's body with flexible straps, and/or structurally on the virtual activity apparatus, whereby mechanical responses are created and delivered thereto; and the at least one processor is configured to arrange the at least one multiple mechanical stimulation unit comprising at least one mechanical stimulator to generate various multiple haptic warnings and/or stimuli, whereby a multiplicity of spatially and temporally different warnings are created.

### CROSS REFERENCE TO THE RELATED APPLICATION

This application is the national phase entry of International Application No. PCT/TR2021/050995, filed on Sep. 30, 2021, the entire content of which is incorporated herein by reference.

### TECHNICAL FIELD

The invention presented hereby generally concerns applications of augmented reality and virtual reality, specifically ones that utilize a vast array of sensory feedback paradigms. Disclosed invention more specifically relates to virtual and augmented reality applications that comprise tactile feedback utilities for a variety of real and virtual acts carried out by human body, such as sports, training/exercise, dance, sex, meditation, driving, therapy etc, wherein tactile information is delivered to certain areas in the body to simulate certain effects of the actions carried out during said activities.

### BACKGROUND

Virtual and augmented reality technology is an ever-growing field that concerns entertainment and other endeavors alike. Among technical fields that utilize virtual and augmented reality technology are military training, therapeutic medicine and sports. In order to increase the amount of immersion by incorporating sensory information into the virtual/augmented reality paradigms, complementary sets of devices and systems are developed in the art.

Document with number WO 2008070824 A2 teaches a tactile wearable gaming device with a tactile garment such as a vest or a body-enveloping device. Said vest comprises a pneumatic force-generating device embedded in multiple cell zones for selective application of modulated force to a user wearing said vest. It further comprises a compressed air source with a compressor and an associated canister to selectively actuate the pneumatic force-generating device to mimic a tactile response. A control valve assembly couples the pneumatic force-generating device to the compressed air source. A controller selectively opens and closes the control valve to modulate the pneumatic force-generating device and generate forces simulating real forces such as impact and G-forces.

Document with number WO 2016178640 A1 teaches a virtual reality device for tactical soccer training, developed in order to provide the players to react in a virtual match emulating conditions of a real soccer match, and in which the quality of the simulated game can be adjusted in accordance with the skills and performance of the players. It comprises a headpiece having at least one three dimensional virtual reality goggle, at least one stereophonic virtual sounder unit providing 3D virtual sound for the movements in a match; at least one user detection unit comprising a sensor or sensors for transmitting the three dimensional model of the user to the simulation generation and calculation unit; at least one haptic feedback unit and simulation generation and calculation unit.

Document number KR 101366444 B1 teaches a virtual shooting system capable of being mutually interlocked in real-time to perform a shooting experience in an environment which is similar to a real combat environment for users regardless of a time and a place of the user by supplying laser firearms, a physical helmet, and a physical vest. Said virtual shooting system comprises a plurality of physical supply units, a plurality of user controllers, and a main server. The physical supply units include a display device, a mock gun, a sensing helmet, and a laser detecting camera. The plurality of user controllers distinguishes a coordinate of laser by analyzing images obtained from the laser detecting camera and converts the detected coordinate of the laser into a coordinate of a virtual space in a shooting simulation.

U.S. Pat. No. 9,968,840 B2 discloses a method and apparatus to provide haptic and visual feedback of skier foot motion and forces transmitted to the ski boot, insole and consequently to the ski/snow interface. System comprises motion and force sensors and a haptic actuator embedded in the skiboot insole in communication with a smart-phone based analysis application, configured to calculate insole motion and orientation and the distribution of pressure points inside the skiboot, then to provide haptic feedback to the skier foot instructing on timing and direction of change in the pressure points necessary to achieve optimal turn parameters. Furthermore, analyzed together with GPS coordinates are transmitted by the application to the cloud based server for further processing. Graphical and numerical representation of data is superimposed over a 3D map of a slope which may be viewed on the user smart-phone or on a remote computer terminal.

US 2013095924 A1 teaches a sports-enhancement system for providing a personalized sports performance experience with three dimensional (3D) virtual data displayed by a near-eye, augmented reality display of a personal audiovisual (A/V) apparatus. A physical movement recommendation is determined for the user performing a sport based on skills data for the user for the sport, physical characteristics of the user, and 3D-space positions for at least one or more sport objects. 3D virtual data depicting one or more visual guides for assisting the user in performing the physical movement recommendation may be displayed from a user perspective associated with a display field of view of the near-eye AR display.

US20130198625 A1 teaches a haptic feedback generation system that can accept inputs from one or more users and that can give haptic feedback to one or more users. The system can utilize network communication of data, various complimentary types of end effectors, various complimentary methods for force generation, and various attachments and accessories.

Comprehensive study by Miles et al. titled “A review of virtual environments for training in ball sports” discusses the relevance of virtual environments and how they achieve tasks with different hardware/software elements, as well as difficulties to overcome. Among those identified as requirements for a virtual sports environment are found display technologies, tracking technologies, haptic technologies for force and tactile feedback and software algorithms. Haptic technologies for force and tactile feedback.

U.S. Pat. No. 7,046,151 B2 discloses a system, method and apparatus of said hardware/software, oscillating motors, a garment, and peripherals that permit users to interact over the Internet or wireless communications network with games or each other users whereby the sensation of touch is felt by the garment user. The invention consists of an interactive body suit that covers the torso. Peripheral gloves, socks, and adult entertainment attachments for men and women attach to the interactive body suit in appropriate locations. Small oscillating motors embedded in the garment and the peripherals produce a vibrating touch sensation when activated. Each motor has a logic address on the suit or peripheral device that correlates to a logical point on a computer graphic representing the user. Contact with the graphic will generate a command signal that activates a motor in the corresponding area on the suit. In one application, limb covers with embedded oscillating motors are used to provide medical treatment massage therapy.

WO 2017178862 A1 teaches a disclosure in the field of computer simulators and games, specifically virtual and augmented reality. The essence of this disclosure resides in the use of a local effect at the fixed point of contact, while transmitting and obtaining a maximum spectrum of sensations in different areas across the entire user's body according to the game situation by using the neuromiofascial web structure and effect imitation interface. The invention substantially expands tactile perception of virtual simulation and game systems without cumbersome special devices and means. At the same time, the involved fasciae are massaged in the process of transmission of interactions. In addition, muscle tension and blocking, joint disorders, bearing may be corrected and physical development and other medical and preventive effects may be produced.

### SUMMARY

Primary object of the disclosed invention is to present a system of virtual/augmented reality.

Another object of the disclosed invention is to present a system of virtual/augmented reality suitable for virtual and real activities such as sports, exercise, dance, sex, meditation, driving and therapy.

Another object of the disclosed invention is to present a system of a system of virtual/augmented reality comprising an enhanced tactile feedback utility.

Another object of the disclosed invention is to present a a system of virtual/augmented reality comprising a biopotential recording utility.

Yet another object of the disclosed invention is to present a system of virtual/augmented reality whereby said recorded biopotentials are used for controlling, maintaining and monitoring the virtual/augmented reality situation user is immersed therein.

Yet another object of the disclosed invention is to present a system of virtual/augmented reality comprising various novel sensor utilities for different sensory feedback paradigms to enhance immersion and sensory modelling.

Present invention discloses an enhanced tactile information delivery system for artificial and virtual reality applications of many different physical activities ranging from dance to meditation, from ball sports to intimate physical activities, that comprises at least one multiple mechanical stimulation unit (MMSU), which comprises at least one mechanical simulator preferably positioned on certain locations on a user's body with flexible straps, and/or structurally on said virtual activity apparatus, whereby mechanical responses are created and delivered thereto.

Present invention also discloses at least one biopotential recording unit further comprising at least one sensor specialized for physiological parameters selected from a group of: electrocardiogram, electromyogram, oxygen saturation level and perspiration meter, whereby control/feedback of said tactile information delivery system is facilitated via the use of data recorded by said biopotential recording unit.

Present invention also discloses different apparatuses which preferably comprise aforementioned multiple mechanical stimulation units. Said apparatuses may pertain to a wide range of physical activities and their devices, such as tennis rackets, soccer shoe sensors, hockey/cricket rackets, golf clubs, baseball bats, sexual simulators. Said different apparatuses are configured to be operated as a part of the feedback utility that enhances user immersion with the modeled actions delivered thereto.

### BRIEF DESCRIPTION OF THE DRAWINGS

Accompanying figures are given solely for the purpose of exemplifying an enhanced tactile information delivery system for virtual and augmented reality applications, whose advantages over prior art were outlined above and will be explained in brief hereinafter.

The figures are not meant to delimit the scope of protection as identified in the claims nor should they be referred to alone in an effort to interpret the scope identified in said claims without recourse to the technical disclosure in the description of the present invention.

FIG. 1A demonstrates isometric top view of a biopotential recording unit according to an embodiment of the disclosed invention.

FIG. 1B demonstrates isometric bottom view of a biopotential recording unit with a strap passing through the slits according to an embodiment of the disclosed invention.

FIG. 2A demonstrates a biopotential recording unit and orientational configurations thereof according to an embodiment of the disclosed invention.

FIG. 2B demonstrates a biopotential recording unit worn on user's body for ECG sensing purpose according to an embodiment of the disclosed invention.

FIG. 3A demonstrates a steering wheel apparatus with conductive parts where positive and negative electrodes are arranged to correspond to different hands according to an embodiment of the disclosed invention.

FIG. 3B demonstrates a bike handlebar apparatus with conductive parts according to an embodiment of the disclosed invention.

FIG. 4A demonstrates biopotential recording unit(s) covering the user's arm and forearm flexor/extensor muscles as well as shoulder deltoids according to an embodiment of the disclosed invention.

FIG. 4B demonstrates biopotential recording unit(s) covering the user's abdominal muscles, forearms, calves, thighs as well as shoulder deltoids according to an embodiment of the disclosed invention.

FIG. 5A demonstrates a mechanical stimulus unit comprising a cap attached to the motor shaft excites a non-rigid floor according to an embodiment of the disclosed invention.

FIG. 5B demonstrates a mechanical stimulus unit comprising a percussion type motion means with a hammer connected to a rod at the end of a motor according to an embodiment of the disclosed invention.

FIG. 5C demonstrates a mechanical stimulus unit comprising one other percussion type motion means with two hammers according to an embodiment of the disclosed invention.

FIG. 5D demonstrates a mechanical stimulus unit comprising a unilateral brushing type motion means with a flexible material at the tip configured to hit the tissue according to an embodiment of the disclosed invention.

FIG. 5E demonstrates a mechanical stimulus unit comprising a configuration wherein a cap attached to the motor shaft excites a non-rigid floor according to an embodiment of the disclosed invention.

FIG. 5F demonstrates a mechanical stimulus unit comprising a unilateral brushing type motion means with two flexible materials at the tip configured to hit the tissue according to an embodiment of the disclosed invention.

FIG. 5G demonstrates a mechanical stimulus unit comprising a material which has increased in volume with pneumatic or voltage control according to an embodiment of the disclosed invention.

FIG. 5H demonstrates a mechanical stimulus unit comprising another view of the material increased in volume with pneumatic or voltage control according to an embodiment of the disclosed invention.

FIG. 6A demonstrates two mechanical stimulators with different peak frequencies placed on upper and lower surfaces on a sheath housing thereof according to an embodiment of the disclosed invention.

FIG. 6B demonstrates two mechanical stimulators placed coplanarly on a surface of a sheath housing thereof according to an embodiment of the disclosed invention.

FIG. 6C demonstrates two mechanical stimulators placed coplanarly on a physically separated surface of a sheath housing thereof according to an embodiment of the disclosed invention.

FIG. 6D demonstrates three mechanical stimulators placed coplanarly on a surface of a sheath housing thereof according to an embodiment of the disclosed invention.

FIG. 6E demonstrates three mechanical stimulators placed linearly on a strap according to an embodiment of the disclosed invention.

FIG. 6F demonstrates three mechanical stimulators placed in a circular arrangement using a strap according to an embodiment of the disclosed invention.

FIG. 6G demonstrates a stimulation configuration comprising a material whose volume may be adjustable via voltage control according to an embodiment of the disclosed invention.

FIG. 6H demonstrates a stimulation configuration comprised of multiple toroid objects manufactured from adjustable volume material, arranged coaxially to form a sheath according to an embodiment of the disclosed invention.

FIG. 6I demonstrates a stimulation configuration comprising an object manufactured from adjustable volume material, in the form of a female gratification apparatus according to an embodiment of the disclosed invention.

FIG. 6J demonstrates a stimulation configuration comprising an object manufactured from adjustable volume material, in the form of a male gratification apparatus according to an embodiment of the disclosed invention.

FIG. 7 demonstrates a collision scene where a mass strikes a surface on the body according to an embodiment of the disclosed invention.

FIG. 8 demonstrates a virtual table tennis apparatus comprising three mechanical stimulation units according to an embodiment of the disclosed invention.

FIG. 9A demonstrates a mountable/wearable lining comprising multiple mechanical stimulation units activated upon a diagonal cut according to an embodiment of the disclosed invention.

FIG. 9B demonstrates a mountable/wearable lining comprising multiple mechanical stimulation units activated upon a mass strike according to an embodiment of the disclosed invention.

FIG. 10A demonstrates a footworn concerning a configuration comprising eight haptic units and four flexible straps connecting said eight haptic units for feet according to an embodiment of the disclosed invention.

FIG. 10B demonstrates a footworn configuration comprising eight haptic units and four flexible straps connecting said eight haptic units for feet according to an embodiment of the disclosed invention.

FIG. 10C demonstrates a handworn configuration comprising two haptic unit for both the fingers and the palm area according to an embodiment of the disclosed invention.

FIG. 10D demonstrates a wholebody configuration comprising multiple haptic units designated for significant locations on the body according to an embodiment of the disclosed invention.

FIG. 10E demonstrates one other wholebody configuration comprising multiple haptic units designated for significant locations on the body according to an embodiment of the disclosed invention.

FIG. 10F demonstrates a head configuration comprising multiple haptic units designated for significant predetermined locations on the head and neck according to an embodiment of the disclosed invention.

FIG. 11A demonstrates a handheld stimulation device comprising mechanical stimulation units and a racketball apparatus attachable thereto according to an embodiment of the disclosed invention.

FIG. 11B demonstrates a handheld stimulation device comprising mechanical stimulation units and a racketball apparatus attachable thereto according to an embodiment of the disclosed invention.

FIG. 12 demonstrates a handheld stimulation device comprising mechanical stimulation units and several different virtual sports-related apparatuses according to an embodiment of the disclosed invention.

FIG. 13 demonstrates a handworn stimulation apparatus comprising mechanical stimulation units and a multiplicity of flexible straps according to an embodiment of the disclosed invention.

FIG. 14A demonstrates an attachable stimulation device comprising mechanical stimulation units according to an embodiment of the disclosed invention.

FIG. 14B demonstrates an attachable stimulation device comprising substantially separated mechanical stimulation units attached to a mobile device according to an embodiment of the disclosed invention.

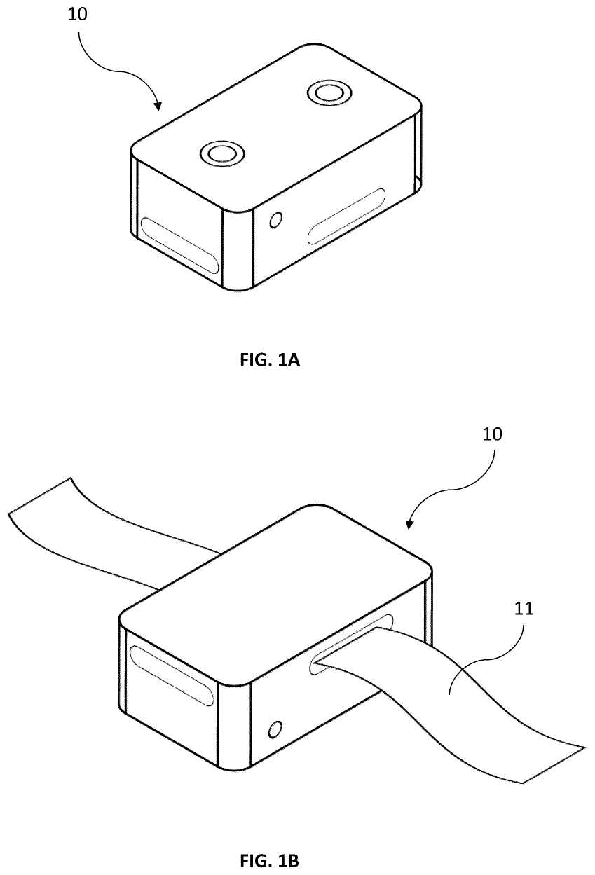

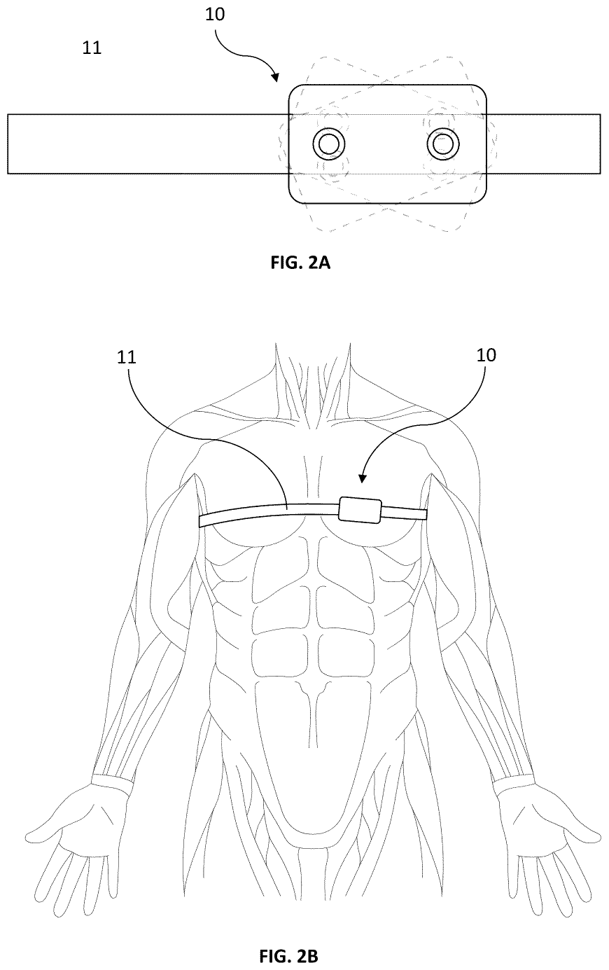

### LIST OF REFERENCING NUMERALS

10 Biopotential recording module
11 Flexible attachment means
12 Virtual steering wheel
13 Biopotential recording means
14 Virtual handlebar apparatus
20 Mechanical stimulation unit
21 Attachment means
22 Toroidal stimulation unit
23 Multi-toroidal stimulation unit
24 Female gratification device
25 Male gratification device
26 Volume-controllable submodule
A Strike path MMSU
B Strike path MMSU
C Strike path MMSU
D Strike path MMSU
E Strike path MMSU
F Strike path MMSU
H Impact region
30 Mechanical stimulation unit
31 Handheld stimulation device
32 Virtual archery apparatus
33 Virtual table tennis apparatus
34 Virtual racketball apparatus
35 Virtual golf apparatus
36 Virtual cricket apparatus
37 Hand-worn stimulation apparatus
38 Flexible strap
39 Stimulation unit region
40 Mechanical stimulation unit
41 Attachable stimulation device

### DETAILED DESCRIPTION OF THE EMBODIMENTS

The present invention discloses a virtual/augmented reality-specific tactile feedback utility that greatly enhances user immersion as well as facilitating means of control and monitoring. In contrast to the existing solutions concerning the facility of various sports such as hockey, tennis, football etc., disclosed invention provides a novel tactile stimulation unit, namely the multiple mechanical stimulation unit (MMSU) that is tasked with accurate modelling of physiological affects relating to the nature of the sports simulated, comprising at least one mechanical stimulator. Disclosed invention further provides different apparatuses for the virtual/augmented enactments of many physical activities such as ball sports (football, tennis, baseball), contact sports (karate, kickboxing), interpersonal activities between people (sexual intercourse, dance) to name a few. Disclosed invention also teaches a biopotential recording/monitoring system that comprises a variety of sensors/receivers that are positioned in many parts of the body with the aid of flexible straps, and are able to record and collect data such as EMG, ECG, SpO2 and respiratory rate. Disclosed invention also comprises systems of data transmission facilitating feedback between the modeled environment and the user in any given setting, via recording of said biopotentials.

Through the entirety of this description, expressions such as multiple mechanical stimulation unit, mechanical stimulation unit, stimulation unit, haptic unit will be used interchangeably, essentially referring to the same thing which is the central aspect of the disclosed invention as described before: A stimulation unit (20, 30, 40), namely the multiple mechanical stimulation unit (MMSU) that facilitates accurate modelling of physiological affects relating to the physical activity in question characterized in that it comprises at least one mechanical stimulator.

Disclosed invention comprises a computerized system which is capable of storing, sending and receiving data to/from other parallel subsystems and systems. Said computerized system is also capable of processing and in necessary cases simulation. In different embodiments, said computerized system may be standalone or in a distributed, miniature fashion. Said computerized system is capable of analyzing data received from other systems and sending outputs to tactile warning, audio and video recording units. As will be elaborated below, in cases where a virtual object strikes a virtual tissue (such as a ball, projectile, knife, sword, etc.), a virtual tissue hitting or touching another virtual tissue (martial arts, collective activities, sexual intercourse), or a virtual object hitting another virtual object (virtual racket-virtual tennis ball, etc.), information regarding e.g. weight, speed, flexibility, rotation is required in order to simulate the information and bodily affect transferred. Said advanced computerized system receives such information from other software and hardware components connected thereto (for example, a simulation concerning hitting a ball with the head simulated on HTC VIVE and an advanced PC, etc.) and utilizes them to stimulate a tactile warning unit, a sound and image output unit and a tissue heat transfer unit. The aim here is to make the simulation more realistic and immersive, whilst relaying a wider array of different information to the actual body, and achieving entertainment, education as well as overseeing of motions and cognitive processes. If necessary, in different embodiments, the information received from the biopotential acquisition and sensing system may also be used for these purposes (for example, increasing or decreasing the amount of energy transferred to the virtual ball in the virtual ball-virtual racket collision case, depending on the state of the monitored muscles). This system may, according to different embodiments, comprise other computerized subsystems, miniaturized or standard-size, e.g. different units for tactile stimulation biopotential recording.

Disclosed invention also comprises a modelling unit. In the art, a non-varying set of body measurements are used for cases of games, simulations or activities. However, body sizes of individuals vary widely. For example, the act of hitting the ball would be different for a 6-year-old child compared to that of an adult person with larger feet. In the disclosed invention, different body proportion instances for these situations may be adapted individually or automatically (e.g., with images captured by cameras, artificial intelligence). In addition, different parameters (height, weight, leg length, gravitational acceleration, ball diameter, weather conditions, etc.) may be changed in real time during the game or activity for purposes such as surprise, entertainment and training.

Disclosed invention also comprises at least one energy unit that is capable of transferring power to different units and subsystems with cable connection. According to different embodiments, such at least one energy unit may be individually comprised in each of said different units and subsystems.

Disclosed invention also comprises a data transfer unit, whereby electromagnetic waves, electric current, optical or auditory data may be transferred in a wired or wireless fashion.

Disclosed invention further comprises a biopotential recording unit. Said biopotential recording unit may comprise at least one of the sensors that measure EMG, ECG, Respiratory rate, oxygen saturation (SpO2), humidity etc. Referring to certain cases, embodiments of this biopotential recording unit may be capable of monitoring and recording ECG/EMG, as well as measuring respiratory rate and skin humidity. In said embodiment, either one of the positive and negative electrodes may be slidably configured along the sensor cover, which are slidable with applied pressure, and lockable when released. Although the electrodes are Ag/AgCl for noise reduction purposes, they may be made from other metals e.g steel, or even non-metal conductor material according to different embodiments. The purpose of the slidable configuration is to optimize the recording and increase the received signal quality for all types of variations in anatomy, such as muscles and heart. A flexible strap passing through the slit on the sensor box attaches the sensor to the tissue. Although the slit may be placed as desired, its proximity to the skin reduces the pressure applied to the tissue, purpose of which is to reduce the feeling of discomfort and to minimize motion artefacts that decrease signal quality. In different embodiments, it may be attached to the tissue using a flexible strap passing through the slit or using a short adhesive tape. Referring to at least one embodiment, a strap perfectly fits said slit, however in embodiments where a narrower strap is used, the recording unit may rotate up to a certain degree (for example an angle of +/−20 degrees). This feature enables the positive and negative electrodes to remain parallel to muscle fibers, thus enabling monitoring and recording the EMG signal more reliably. With the aid of holes and coarse perturbations on the reusable, cleanable flexible strap, perspiration-induced moisture is able to escape between the band and the skin. According to an embodiment, a biopotential unit that may be connected both vertically and parallel to the electrodes (the version connected in parallel with the electrodes is for better quality recording of ECG signals, other is preferably heart potentials).

In different embodiments, said biopotential recording unit may contain a rechargeable battery inside, or it may be powered and transfer data via a data transfer and charge cable connected thereto. Said biopotential recording unit may also accommodate sensors such as accelerometers, and it is configured to detect motion artefacts to improve signal quality and when it is deemed necessary to be volume and cost efficient (due to the combination of multiple sub-parts). It comprises moisture meter and SpO2 sensor holes on a part of the sensor surface facing the skin. The purpose of the moisture meter is to measure the amount of perspiration or moisture, thus detecting the presence of a short circuit or variable low impedance between the electrodes that may disrupt the biopotential readings. The purpose of SpO2 sensor is to determine blood oxygenation level as well as the indirect respiratory rate. At least one side of said biopotential recording unit comprises inputs that may be used for charging and cable data transfer. Said sensor multiplicity can save data digitally and transmit it through wire or wirelessly. Other embodiments may lack some of the aforementioned features. A miniature computer comprised therein may be used for data processing purposes such as calculating heart rate, respiratory rate, etc.

In an embodiment, an ECG sensor connection established via a flexible strap (or alternatively a short adhesive tape) is comprised. ECG may be recorded simultaneously along with SpO2, thus enabling simultaneous determination of respiratory and heart rates using the mini computer comprised therein. In an embodiment, said unit comprises a 3D sensor unit, which is capable of measuring the depth of breathing indirectly based on chest movements, as well as measuring the respiratory rate from the amount of change in force, using the force sensor on the flexible strap.

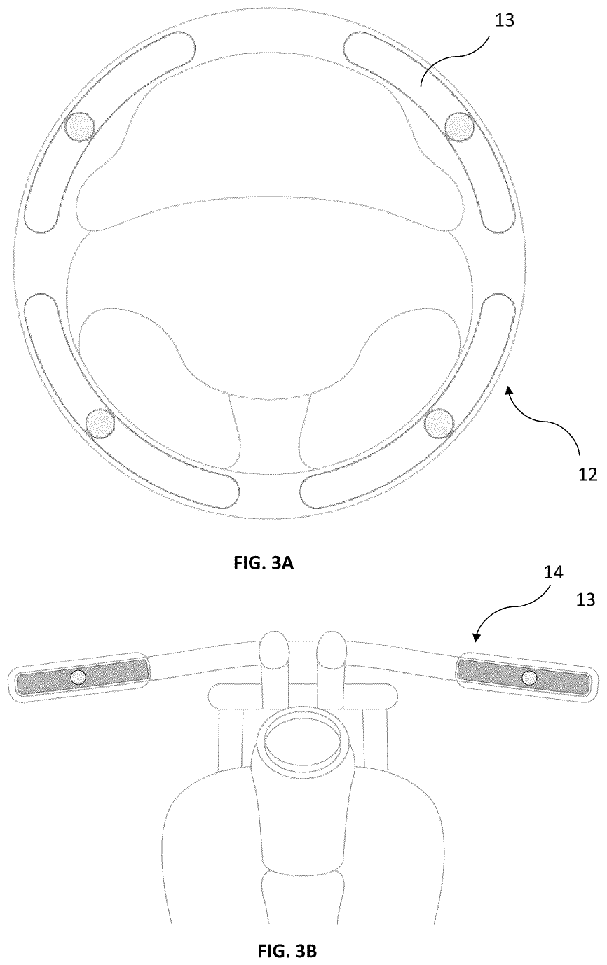

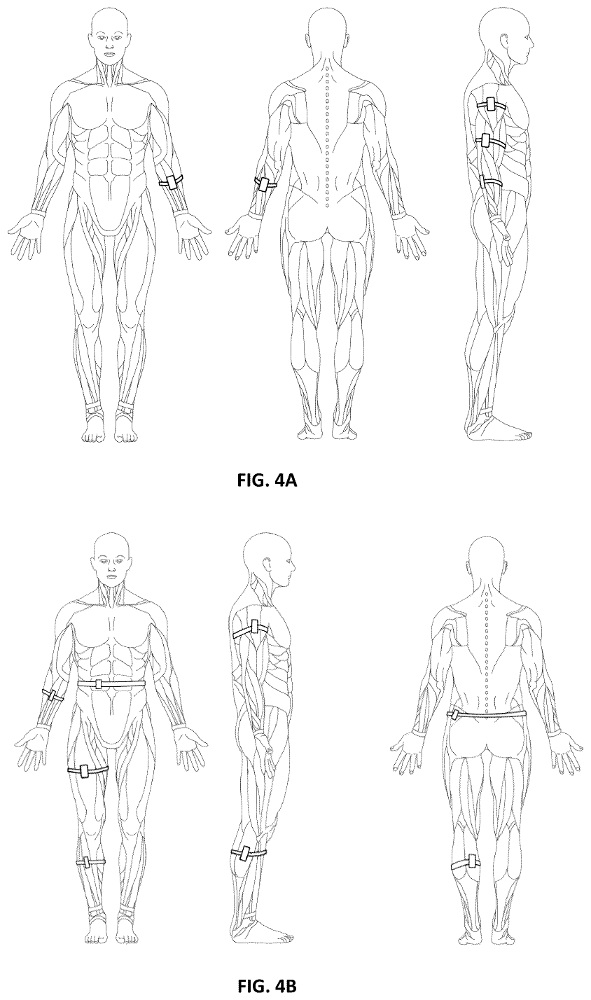

Referring to FIG. 3A, what is demonstrated is a steering wheel for gaming divided into 4 conductive parts, with said conductive parts connected to two multiplexers and multiplexer outs connected to a biopotential unit. When right and left hands touch two of the 4 metal (or non-metal) conductive parts on the steering wheel, the potential difference between the left and right hands may be amplified, enabling ECG recording and heart rate measurement. In different embodiments, the number of conductive parts may be increased or decreased, multiplexers may be removed to record directly between said conductive parts. Said biopotential unit and other circuit parts are placed in a way that does not cause undue disturbance for the user. Next to gaming purposes, a different embodiment may also be used in real vehicles, and it can be used to determine the driver's cardiac health, sleep and alertness status, and intervene in the game or drive if necessary. A similar embodiment is demonstrated in FIG. 3B, implementable on real and virtual motorcycles and bicycles.

In an embodiment, said biopotential unit is comprised as part of an embodiment where said flexible strap is attached to the body to cover gluteus medius and rectus abdominus muscles. This embodiment may also be a part of a suitable mechanism for recording and modulating activity during sexual exercise. Other embodiments exist where leg and thigh flexor-extensor muscles; arm, forearm flexor-extensor muscles are covered. In the same embodiment, further appropriate positioning of said biopotential unit is comprised on shoulder muscles. All biopotential units are set up for recording muscle signals (EMG) and are configured to record said muscle signals for types of sports and exercises that require movement of hands and arms. Since the biopotential unit is configured to be able to rotate, the positive and negative electrodes of the unit are able to record the optimal muscle signal, whereas perspiration and moisture can escape from the bottom of the strap and the user discomfort is minimized with the aid of holes positioned on said flexible strap.

In ball strikes in different sports (football, tennis, volleyball, etc.), the trajectory of the ball post-strike depends on the extent the muscles involved in the motion contract. Electromyography (EMG) is a reliable medium to detect the extent of contraction of superficial muscles. Since the EMG intensity of the muscles involved varies from person to person, EMG signals should be normalized (Ball and Scurr 2013; Burden 2010 with respect to the art). The purpose of normalizing is to determine the level of strength generated by the EMG signal in question. Disclosed invention also teaches a novel method for assembling and normalizing EMG next to the methods known in the art. First, various different movements are made for correction of placement and grading/normalization process of the EMG. Next, for EMG normalization, the user is required to hit a real ball (football, tennis, etc.) or a virtual ball at least once at different speeds, whereby the system determines the speed of the striking limb (with the aid of a camera, VR, accelerometer, etc.), calculating which EMG amplitude corresponds to which striking speed. Based on this, corrections and adjustments may be made regarding collision mechanics. For example, in the case a real ball hits the real foot, provided that the foot, leg and thigh positions remain the same, two outcomes are possible: A case where the leg muscles do not contract at all or another case where they strongly contract. In both cases, both the trajectory of the ball and the player's sensation would yield quite different results. In such cases, EMG signal level recorded during VR or other activities allows the collision mechanics of simulation to be corrected i.e., if the muscles contract less, EMG signals would be low and the speed of the ball would consequently be reduced or the reflection speed of the ball is determined more accurately, concurrent with the principle of more realistic modelling. The same also holds for other sports, even ones of different rules and nature such as tennis and baseball.

In various embodiments of the disclosed invention, wearable EMG sensors/receivers are placed on flexible staps, and thus may be attached to locations on the human body such as arms, forearms, shoulders, legs, thighs, etc. Preferably miniature, said EMG sensor/receiver apparatus is slidably configured on said flexible strap, and is lockable in place in a secure fashion, to obtain data from the appropriate vicinity of the muscle. In certain embodiments, elastic belts are comprised, attached to the leg and thigh regions, for sports based on kicking the ball; and to the arm, forearm and shoulder areas for sports that require the use of hand and arm. In various embodiments, a miniature EMG receiver may also be comprised slidably thereon.

EMG utility in the disclosed invention enables flexible modelling of the foot-leg-thigh, etc., further enabling ball strike mechanics to be modeled more accurately and the ball trajectory to be determined more realistically. These together contribute to the simulation, game or activity to be modeled with an unprecedented level of realism. Concurrently, a user is rendered capable of receiving a different, more realistic array of warnings with the aid of the aforementioned stimuli. When the ball hits the foot at a certain velocity, for example, if muscles that stabilize ankle and knee joints and generate force are strongly contracted, the foot will respond to the ball strongly; but if said muscles are relaxed, the energy of the incoming ball is absorbed by the foot at the location of the impact causing the return trajectory to be uncertain. In another embodiment as an example wherein boxing and tennis games are stimulated, the degree of contraction for muscles that generate force and stabilize joints will change the impact of the punch or the racket coming into contact with the tennis ball. As muscles get loose, amount of force delivered and impact decrease, which is in turn determined by realistic modelling.

According to some embodiments, disclosed invention may further comprise at least one of the following sensors depending on the intended use of an embodiment in question: Miniature 3-axis accelerometer, magnetometer, gyroscope, altimeter, air pressure meter, temperature and humidity meter, audio and video recording, force and pressure sensor. In different embodiments, a selection of the sensors above may be utilized to measure the position, heading, position, velocity and acceleration of limbs, body parts and apparatuses such as rackets; to detect heat and tissue humidity; to determine the respiratory rate and to record audiovisual content pertaining to the user.

Disclosed invention further comprises a multiple mechanical stimuli unit (MMS unit or MMSU hereinafter). In the available art, a single vibration motor rotates or vibrates at a constant peak frequency, thus leaving only vibration duration and vibration intensity as potential variables when transmitting information.

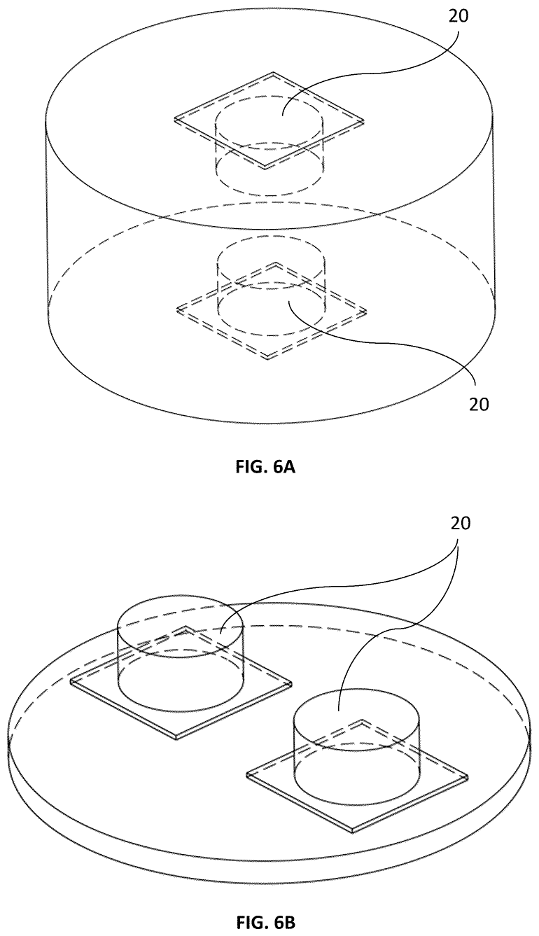

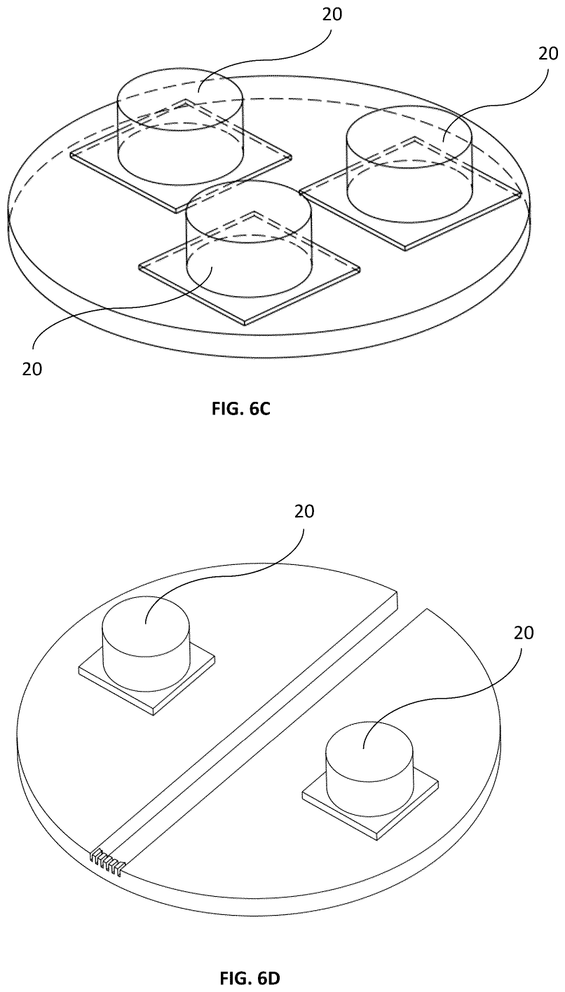

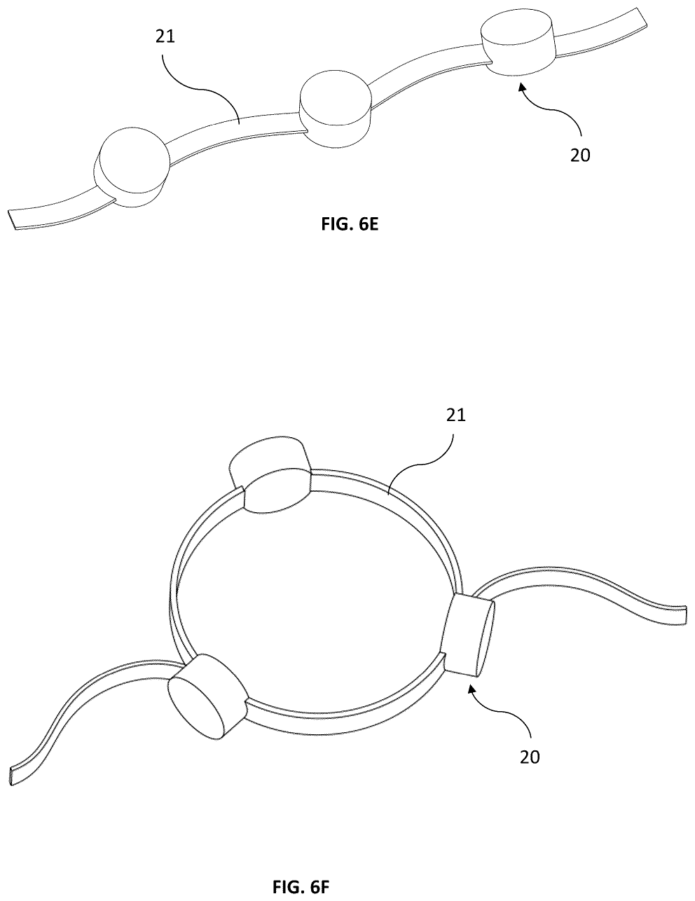

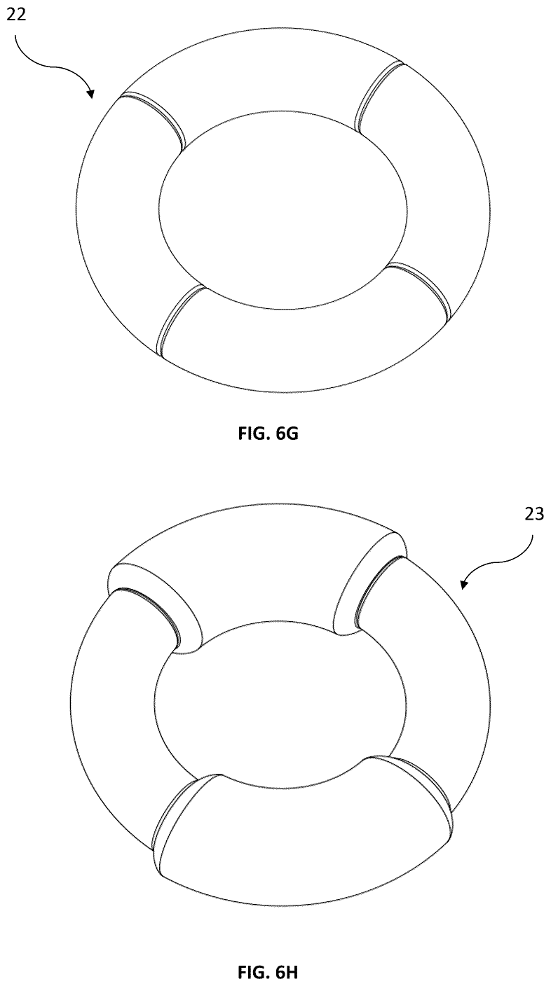

In the present invention, beyond what's known in the art, at least one mechanical stimulator/exciter capable of operating at multiple peak frequencies (e.g. 170 Hz and 250 Hz respectively) are disclosed. Different peak frequency values at different vibration intensities may also be simultaneously operational. In an embodiment, two mechanical stimulators with different peak frequencies are comprised, whereby said two mechanical stimulators are placed on the lower and upper surfaces of the sheath housing thereof referring to FIG. 6A. In an embodiment, two mechanical stimulators positioned on the same surface are comprised, referring to FIGS. 6B and 6C. In other embodiments, three mechanical stimulators may be comprised on the same surface, referring to FIG. 6D.

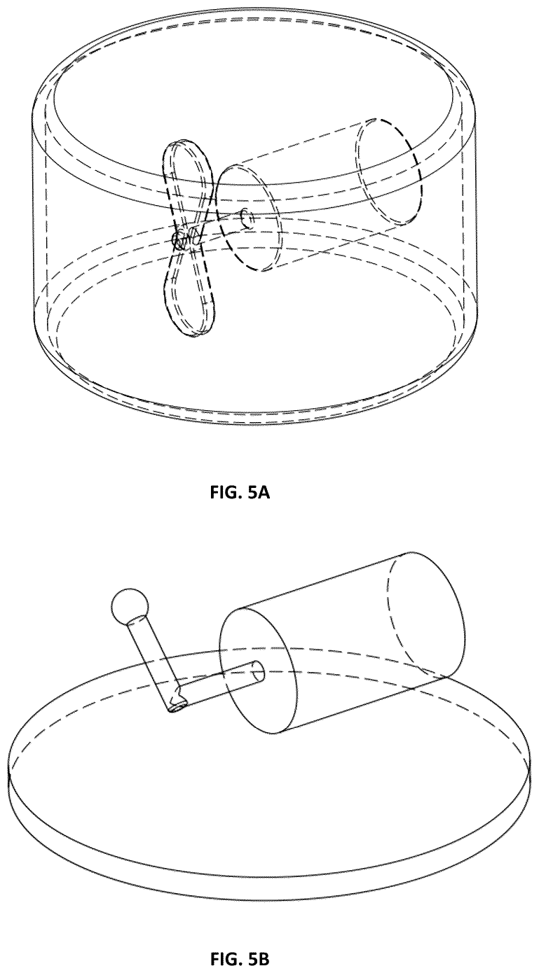

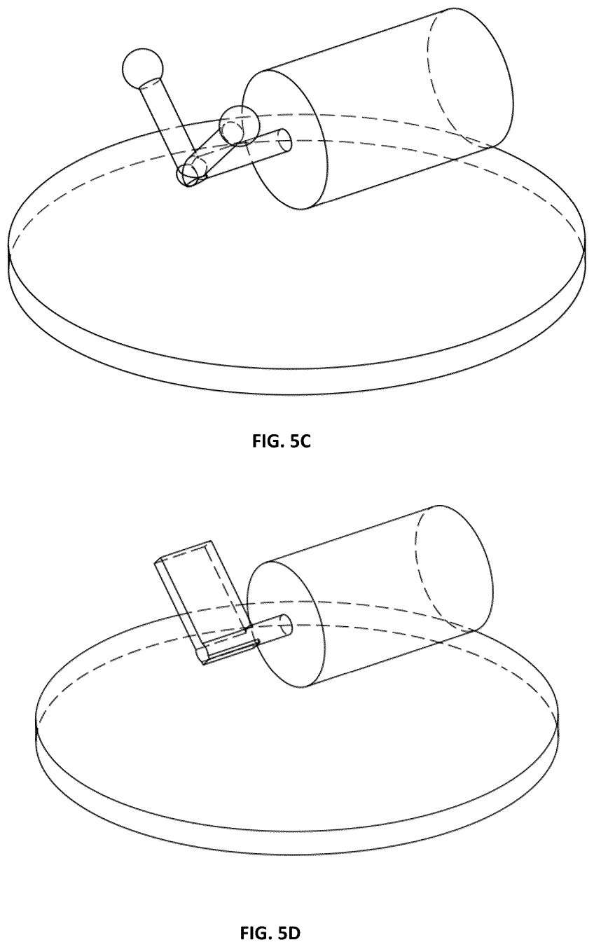

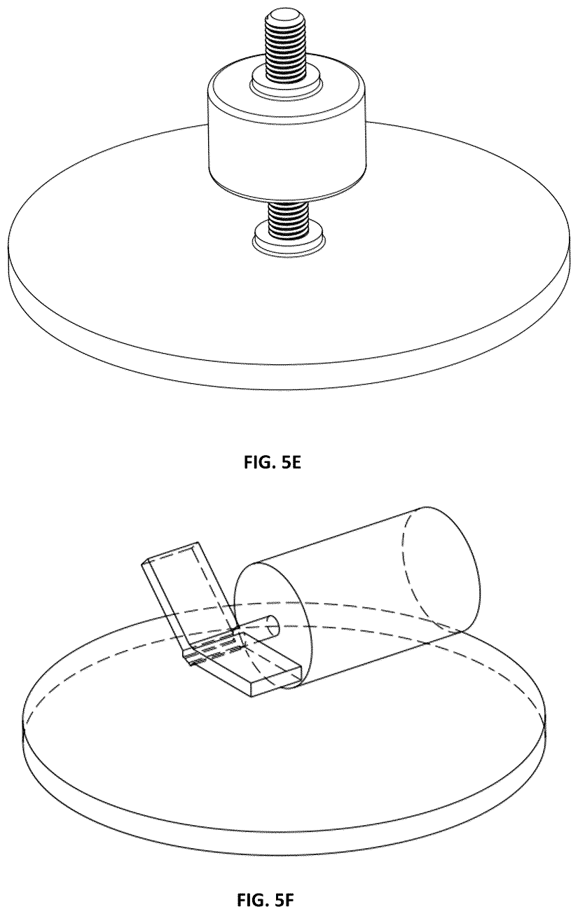

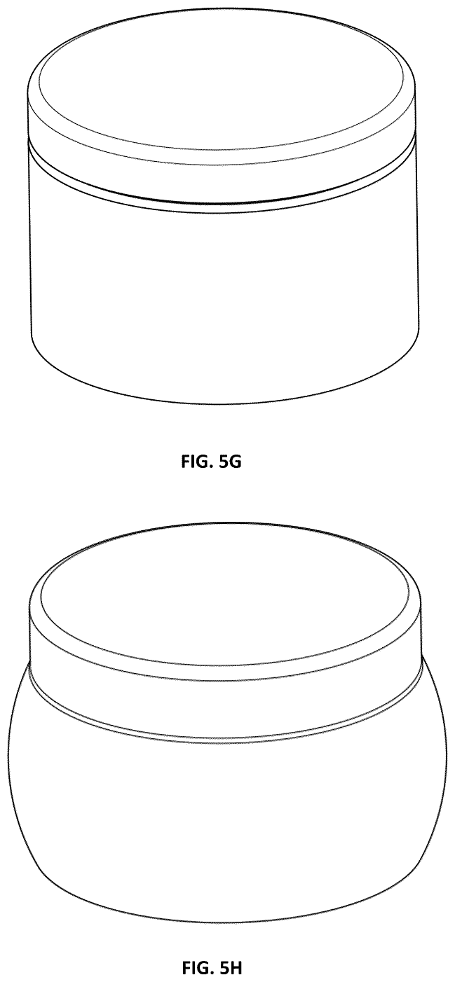

In an embodiment, a percussion type mechanical stimulator is comprised where a hammer connected to a rod at the end of a motor strikes two areas on the tissue with one half revolution in either side, referring to FIG. 5B. Thus, a sense of touch that is different from vibration-type mechanical stimulation is achieved. In different embodiments referring to FIG. 5C, a double-hammer mechanical stimulation configuration may be present. What is particularly advantageous regarding this mechanical stimulation configuration is that it shortens the reaction time as well as improving the pulse frequency. According to various other embodiments, different configurations may be present which comprise an increased number of hammers, gears, additional mechanisms present for said MMSUs. Area on the sheath struck by hammers may be closed, or open so as to directly establish contact with the skin in different embodiments.

In a particular embodiment according to FIG. 5A, a unilateral brushing motion type mechanical stimulator is comprised, whereby a flexible material at the tip hits the tissue through continuous rotation, stimulating the tissue. In order for the flexible part not to damage the tissue, a layer exist between the tissue that can stretch without diminishing the force delivered. Such a sense of touch is different from vibration type motors and it can stimulate the receptors related to touch differently. A double-wing brushing motion type is comprised in a particular embodiment. According to different embodiments, combinations of various types of mechanical stimulators are possible. Said mechanical stimulators may contain a greater quantity of wings if desired; along with different combinations capable of being realized by mounting different gears and additional mechanisms.

In an embodiment, a gear configuration whereby force is applied on the tissue is comprised. The mechanical stimulator rotates and pushes the flexible lower end of the box against the tissue, referring to FIG. 5E.

In an embodiment, a mechanical stimulation unit is comprised wherein a material is used that may increase or decrease in volume with pneumatic or voltage control.

In an embodiment, a cap attached to the motor shaft is configured to excite a non-rigid floor. Said non-rigid floor may be, according to different embodiments, covered/coated with lubricant material to reduce noise and wear referring to FIG. 5D. In different embodiments, said motor shaft may have multiple caps attached thereto, referring to FIG. 5F.

In an embodiment, a MMSU is comprised wherein a stimulation configuration is realised comprising a material whose volume may be adjustable via voltage control. Such materials are known in the art, e.g. study by Gladisch et al. titled “Reversible Electronic Solid-Gel Switching of a Conjugated Polymer”. According to one embodiment, one such toroidal stimulation unit (22) is comprised. According to another embodiment, a multi-toroidal stimulation unit (23) is provided comprising four volume-controllable submodules (26) which expand upon control. In one embodiment, said MMSU is comprised of multiple toroid objects manufactured from said material, arranged coaxially so as to form a sheath. By adjusting the volume of said multiplicity of toroid objects, pressure or force stimuli may be produced onto the tissue in a certain direction. One such embodiment discloses a female gratification device (24) comprising multiple volume-controllable submodules (26), and another embodiment discloses a male gratification device (25) which again comprises multiple volume-controllable submodules (26), individually controllable for delivering said pressure or force stimuli.

In cases where multiple mechanical stimulators are present on a hard surface, their movements may destructively interfere. To overcome this problem, disclosed invention comprises a structure isolating (i.e. reduces interaction between) different instances of mechanical stimuli, referring to FIG. 6C. Referring to an embodiment, one such isolating configuration is comprised whereby spaces are left between distinct MMSUs. Referring to yet another embodiment, two instances of MMSUs formed by separation of mechanical stimulators via individual sheaths are comprised, whereby mechanical stimulation properties of each unit may be different or identical or similar to a certain extent. Different embodiments wherein different isolation measures (e.g. placement of materials with different elastic properties between mechanical stimulators) are also possible, whereby interference problem between different MMSUs is addressed and the sensory separation of individual MMSUs is further facilitated, referring to FIGS. 6E and 6F.

In different embodiments of the disclosed invention, different types of MMSUs with different stimulation properties may be combined whereby the array of different stimuli that can be delivered to the tissue via said combinations of aforementioned types of mechanical stimulators are realized.

In various embodiments of the disclosed invention, mechanical stimulators can be used to different extents of synchronicity and intensity along with other types of stimuli (sound, vision, electrical, smell, taste etc).

In different embodiments, each MMSU may have as its energy source a battery (rechargeable and/or changeable) therein, as well as using energy from outside with a cable. MMSUs attached to the body may have multiple charging and data transmission sockets. The reason for the existence of multiple sockets is to facilitate data and power transmission to similar MMSUs in the vicinity.

In different embodiments of the disclosed invention, an MMSU may comprise a mini computer with storage feature, as well as various specialized sub-units capable of communicating through wireless (EM waves: Bluetooth, Wi-Fi etc.) and/or wired (IIC, SPI, etc.) protocols. Such actions may be performed over continuous data transmission with time stamps, or by a predefined pattern stored in said mini computer (e.g., activate the first motor with intensity a for x ms, activate the second motor with intensity b after 20 ms, stop the first motor after 200 ms, etc.).

While haptic systems do not vary for individual users in the art, disclosed invention enables MMSUs to be calibrated according to the user and the location thereof on the user. While this novel feature may seem insignificant for relatively naked surfaces such as hands and arms, areas with dense hair (head) or cases of neurological diseases where sensibility is compromised are addressed with this feature. For this purpose, a user is given stimuli of different intensities and purposes, the MMSU is calibrated based on user feedback between minimum and maximum values (or for different intensities), and the settings are stored in the MMSU itself and/or in another unit such as an external computer.

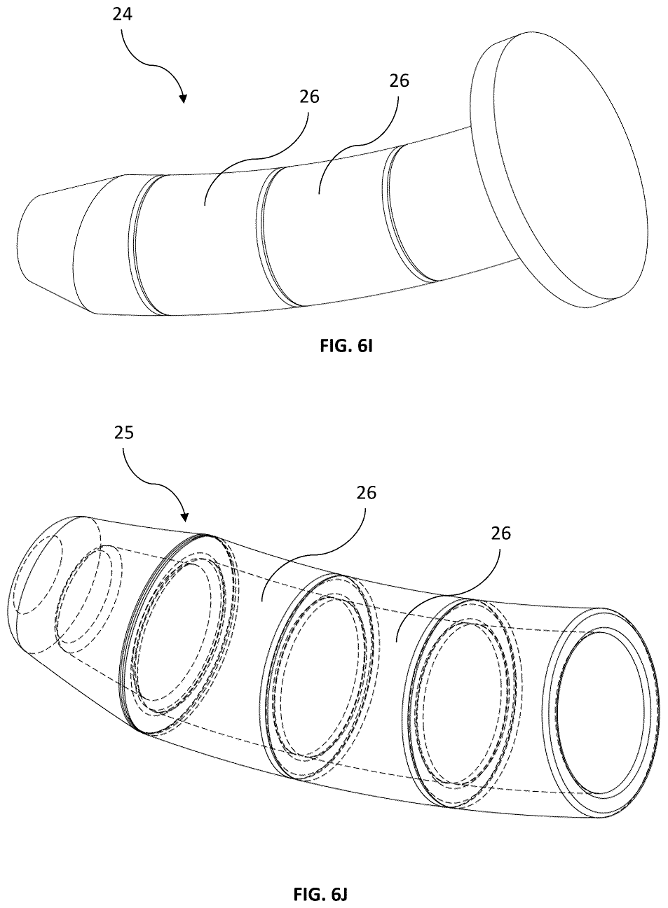

In teachings known in the art, a user's skin is stimulated in case of a ball/bullet-body part (skin, etc.) collision. For example, a user is (in real life) capable of differentiating between cases where a ball hits the chest perpendicularly, or with an angle of 60 degrees. In the disclosed invention, MMSUs are capable of stimulation based on the quantitative information about the collision (such as impact velocity V, impact angle B with the surface normal, angular velocity of the object W) on a collision zone A (referring to FIG. 7). In an embodiment, impact velocity v may be transmitted to the tissue by one instance of mechanical stimulator in the MMSU, whereas other information related to collision (θ, ω) may be transmitted by other instances of mechanical stimulators, again in the same MMSU. Referring to FIG. 8, In another case where a collision occurs between a ball and a hand-held racket-like apparatus, torque is also taken into account. Disclosed invention is also capable of transmitting the mechanical effects of said torque to the tissue via different mechanical stimulators in the MMSU: In an embodiment, of the mechanical stimulators of MMSUs on the hand-held apparatus and worn on the body; one (30A) encodes rotation in one direction while the other (30B) encodes the rotation in the opposite direction.

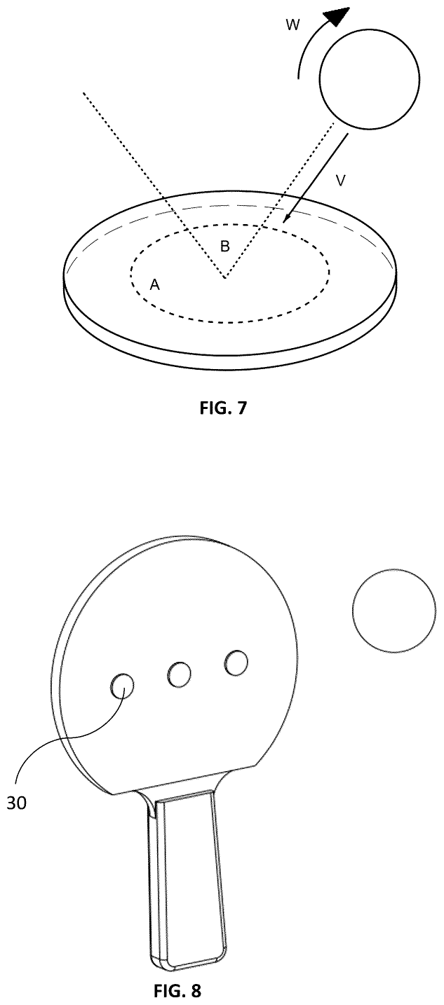

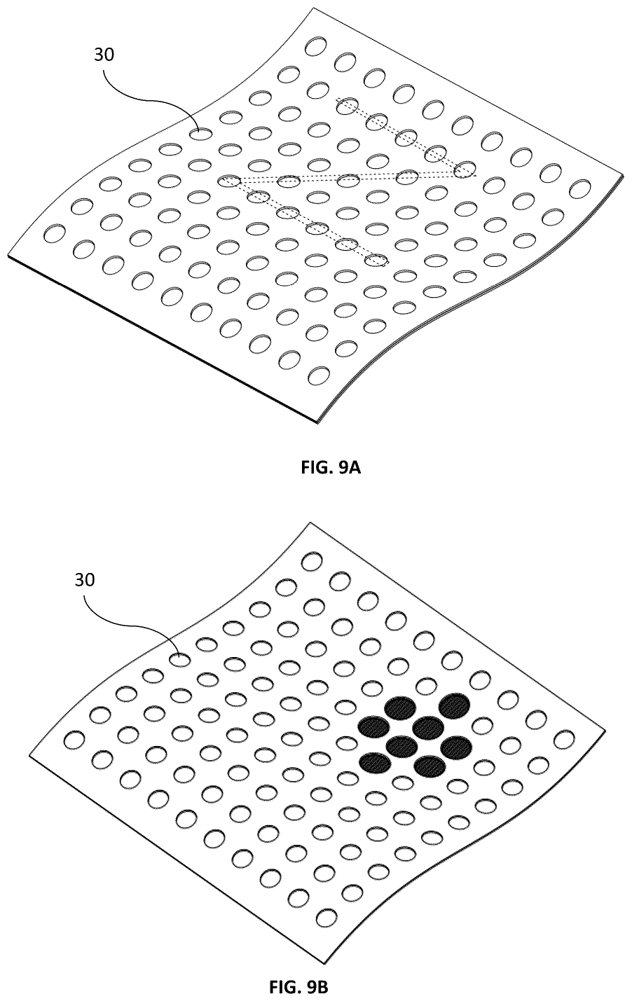

In a particular embodiment, what is comprised is an example of a jacket lining mountable/wearable on the chest-abdomen portion and/or back-side portion of the user's torso. According to an embodiment concerning a configuration referring to FIG. 9A, when a virtual sword virtually cuts the virtual body from the upper right corner to the lower left corner; MMSUs A, B, C, D, E and F on the incision path/area stimulate the tissue with a certain mechanical stimulus, while the depth of the cut may be modelled with other types of mechanical stimulators in the same MMSUs. Said MMSUs on the incision path may be stimulated based on a time pattern, such as one denoting the order in which they are stricken. In addition, said MMSUs may be stimulated based on different time intervals, whereby each individual MMSU may be configured to exert various different stimulation patterns.

In an embodiment of the disclosed invention concerning an application wherein a bullet hits region H on the skin, causing haptic stimuli to spread outwards to other MMSUs in the vicinity, starting from the MMSU closest to region H. The intensity of the bullet impact as well as the depth of the wound are modeled by different mechanical stimualtors in the MMSUs. Similarly, when a hot, damaging substance comes into contact with the body, haptic units in the area are activated. Different multiplicities and profiles of mechanical stimulators are activated depending on the modeled severity of the situation. If a bullet or sword enters from one part of the body and exits from another, the same operations may be timely carried out, in regions corresponding to the entry and exit wounds via MMSUs closest to the region. Said MMSUs on the strike path may be stimulated based on a time pattern. In addition, said MMSUs may be stimulated based on different time intervals, whereby each individual MMSU may be configured to exert various different stimulation patterns.

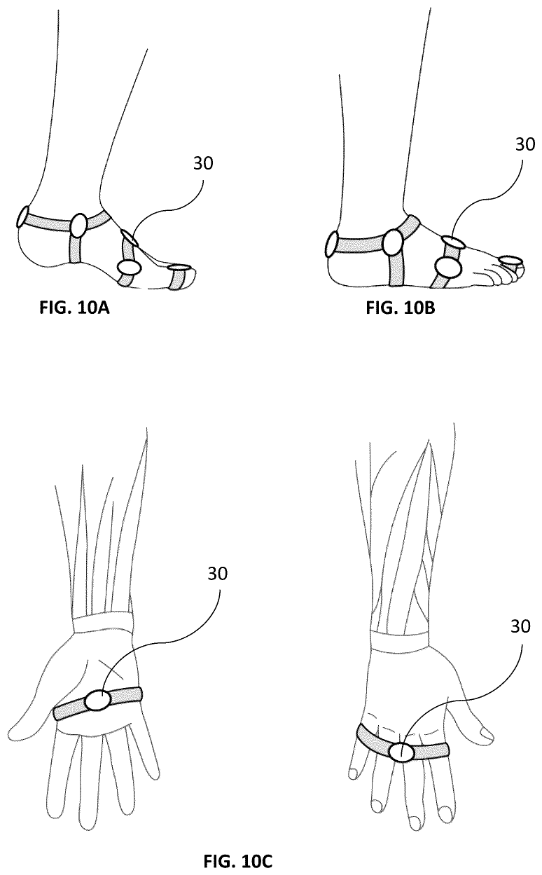

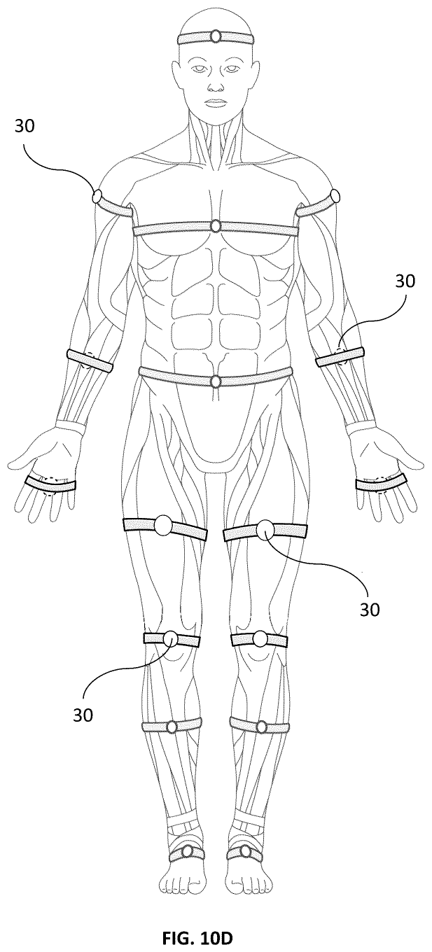

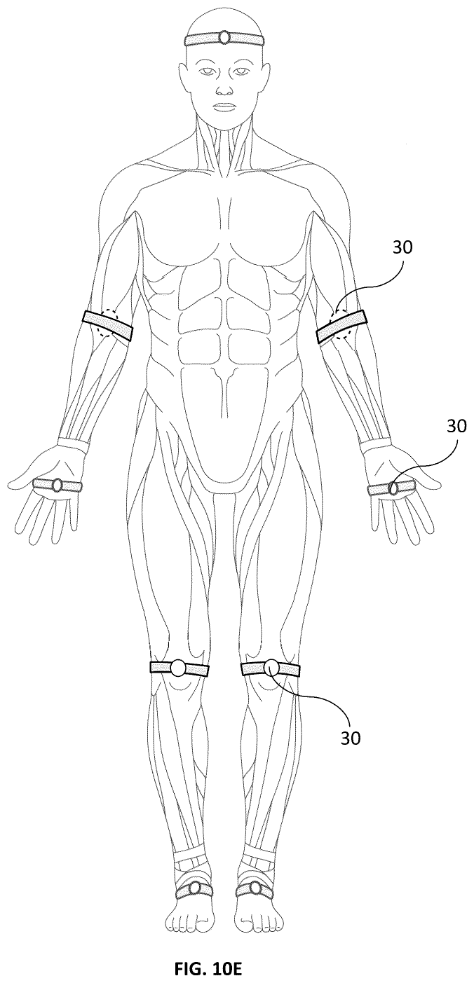

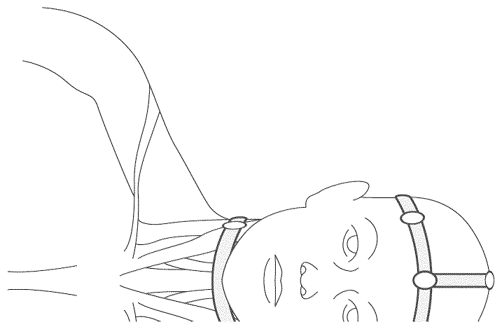

A certain embodiment is characterized by a configuration comprising eight haptic units and four flexible straps connecting said eight haptic units. Albeit said one embodiment discloses a configuration comprising eight haptic units, quantity of said haptic units may be increased or decreased accordingly, referring to FIGS. 10A and 10B. This configuration devised for sports where hitting a ball with the foot is important, may also be adaptable for use inside a shoe. One particular haptic unit, which is located on the long arch of the inner foot, is designed to be relatively smaller and thinner. Purpose of this design choice is to enhance the mechanical affect for strikes with/on the sole. At least one of said haptic units is optionally equipped with miniature light sources such as LEDs, and may be used for determining positions thereof within the context of 3D VR systems. According to an embodiment, a configuration is present wherein a virtual ball-virtual foot collision is modeled. When the virtual ball hits the 3D model of the foot; MMSU(s) closes to the region may transfer the impact velocity, whilst other MMSU(s) may transfer other parameters such as ball rotation and collision angle to the foot with the multiplicity of different mechanical stimulators.

Referring to FIG. 10C, an embodiment where a configuration comprising one MMSU (30) for the palm region and one MMSU (30) for the outer face of the fingers is disclosed. In said embodiment, a connection is provided with two flexible straps, and the number of MMSUs may be increased. In different embodiments, MMSUs may be provided in the interior portion of a glove as well. For the glove used for ball-hand collision cases (e.g. goalkeeping), collision velocity may be delivered by one type of mechanical stimulator in MMSUs, whereas affects of parameters such as angle of impact and ball rotation may be delivered by other mechanical stimulators. For sports such as volleyball, additional MMSUs may be placed on the hand and may be supported with additional MMSUs for the forearm according to different embodiments.

Referring to FIGS. 10C, 10D and 10E, in embodiments of the invention specifically targeting combat sport configurations, multiple MMSUs are attached to significant locations on the user's body with flexible straps. Said significant locations may be critical strike regions as well as locations where contact frequently occurs. Similarly, the impact severity and effect (which are different for bone-vs-bone and bone-versus-soft-tissue cases) may be modeled and delivered to the user with different mechanical stimulators on MMSUs.

With non-narrow (wide surfaced) apparatuses such as rackets, a ball strike induces rotational movement i.e. torque on the apparatus depending on the location of the impact. In an embodiment of the disclosed invention, the virtual racket system referring to FIG. 11A is comprised by two removable MMSUs (30C and 30D) and a tennis racket. When a virtual ball hits the virtual racket, speed of the ball hitting the racket surface and the angle of the impact with respect to the racket surface as well as the torque applied may be modeled by different mechanical stimulators in MMSUs. For example the magnitude and angle of impact may be delivered with MMSU X (30C), while the torque may be delivered with a different mechanical stimulator of MMSU Y (30D). In addition to MMSUs on the outer surface of the racket, other MMSUs may be integrated within the structure of the racket instead of being attached to the tennis racket externally. In various embodiments, referring to FIG. 11B, the number of MMSUs may be increased or decreased and/or structurally associated with different parts of the racket. In an embodiment of the disclosed invention, assembly of the virtual racket may be realized on a standard tennis racket, or alternatively on a racket with an elastic layer placed between two MMSUs. The reason for using the elastic layer is to isolate or minimize the amount of differentiation between different mechanical stimulators at the handle, so that the stimuli delivered from MMSUs X and Y may be easily distinguishable by the user. Another embodiment where a configuration comprising five MMSUs and two optional elastic layers are demonstrated referring to FIG. 11B, where MMSUs Y (30E) and Z (30F) are specialized for delivering the moment information for torque). Another embodiment is also disclosed wherein another apparatus comprises two MMSUs and an elastic layer, whereby additional weight maybe attached to or subtracted from racket body to better simulate sports such as archery (32), ping-pong (33), tennis (34), golf (35), cricket (36) etc. referring to FIG. 12. Said apparatus may comprise a 3D sensor unit for determining angle and position; a speaker for simulating ball impact sounds, and light sources with adjustable timing and color for detecting location in 3D VR (e.g. multicolor LED). A more advanced version is comprised in another embodiment, wherein the number of elastic layers is increased to three.

Present invention also comprises a heat transfer unit (HTU). Said heat transfer unit is used to heat or cool the tissue for purposes such as giving feedback, entertainment, surprise and general stimulation. Said HTU may comprise either one of: thermoelectric devices using the Peltier effect that heat and cool the tissue, ThermoReal generators using the Seebeck effect that can quickly cool and heat the tissue, resistors that can deliver heat generated via electricity, computer-controlled gas coolers, transducers that heat tissue with ultrasound, electromagnetic wave-based heaters or their functional equivalents.

It is known that a ball (football, ping-pong, etc.), bullet, a sharp or a blunt object is capable of delivering heat as a result of a strong enough impact or blow. Physiological affects emanating from this are sensations of heat and paradoxical cold. The invention comprises the feature of heating and cooling the tissue for some embodiments. The advantages of this situation are to make the hitting and touch sensations realistic; There may be situations such as adding surprise and excitement to game, simulation and activity.

The tissue heating/cooling feature of HTUs may be, according to various embodiments, combined with other types of stimuli (audio, visual, electrical, smell, taste, etc.) to various extents of synchronicity and intensity. Said feature may be used as a stand-alone unit or mounted on other stimulation units (e.g. MMSUs). According to another embodiment, a unit that can heat and cool the tissue situated between two different coin-type mechanical stimulators is disclosed.

A variety of haptic alert-information delivery schemes are utilizable for augmented and/or virtual reality applications of medicine. With the disclosed invention, information regarding proximity to a critical or selected tissue may be delivered to the user via haptic alerts. Devices that cause separation and perforation in the tissue such as needles, scalpels; lasers directed to the tissue such as X-ray or gamma rays are thus accounted for haptically. In an embodiment, distance to a tissue may constitute one part of haptic stimuli, whereas tissue type may constitute another part of haptic stimuli. In other embodiments, haptic alerts delivered to the user may be in the form of a single haptic stimulus which may serve merely as a warning.

In mobile devices capable of providing haptic stimulation such as cellphones, the entire device poses a single piece of mechanical and haptic unity, wherein usually a single (however, there may be more) vibration motor transmits haptic information to the user over the physicality of the device in the absence of a haptic transmission filter. For example, when one of two haptic units on either sides of the cellphone is activated, it may be felt on either side of the phone. If a filter is positioned that reduces haptic transmission between right and left sides of the phone (such as an elastic piece that is positioned between the right and left PCBs, or any sort of physical separation is kept between PCBs, in which case alerts from right and left may be separated more efficiently). According to an embodiment referring to FIGS. 14A and 14B, an attachable stimulation device (41) comprises sufficiently isolated MMSUs (40). With the present invention, a greater amount of haptic information may be transmitted to the user, thanks to both the spatial haptic filter and separable haptic alerts.

Disclosed invention, in its various embodiments, proposes a solution for the visually impaired as well. Visually impaired people experience various difficulties in life due to their disability. With this invention, spatial information regarding the environment of the user, such as approaching vehicles, other people, objects, etc. may be transmitted to the user, encoding information pertaining to distance, size and shape of said objects via multiple haptic stimuli. This way, ordinary vibrational information that change in timing and intensity known in the art is surpassed.

Disclosed invention, in its various embodiments, proposes a solution for the hearing impaired as well. With this invention, information pertaining to sound with regards to its source and proximity (such as the type and activity of the approaching object, e.g. a barking dog, a walking child/adult, vehicles, people, objects etc.). Such information transmitted to the user may include distance, size and shape information.

For virtual and augmented reality applications, limits of spatial touch sensation are important, such as holding an object between two fingers or securing a ball between the ground and the user's foot. While in real life the object or a ball cannot be compressed, virtual reality may allow for such a configuration. With the disclosed invention, features such as the perceived flexibility of the body held or compressed, its compression limit and other information may be transmitted to the user through different haptic elements/components, as previously mentioned.

There are certain real-life processes that require extensive management of a particular device. Such processes include exoskeletal device management and robotic medical device management. Such treatment procedures are utilized to increase the effectiveness of weak limbs, and as such make information exchange between the user and the device quite important. Places where an increased amount of noise is present or where visual perception is problematic pose certain difficulties to the effective control of such devices. With the disclosed invention, the parameters of the managed device may be transmitted to the user via a multiplicity of haptic alerts.

Real-life medical emergencies such as increased heart rate, arrhythmia, infarction, high blood pressure, abnormal blood glucose level may be life-threatening. With the disclosed invention, such measured values may be used to generate haptic alerts for the user in order to warn them about said emergencies.

In virtual conference environments such as conference calls, remote lectures etc., usually an image representing the person speaking appears on the screen when a person in said environment asks a question or takes a turn to speak. In real-life environments, people speak from an actual material physicality, such as a chair in a conference room or a seat in a hall, with their speech and appearance being correlated with where they are in the human cognition. With the disclosed invention, such virtual conference may be modelled where a blackboard, a presentation screen and participants are placed in certain places in virtual 3D-space, configured such that when the speaker and/or participants/users turn their head or eyes towards another participant in said 3D VR environment they hear the voice of said another participant louder. Also, when a lecturer is the center of attention when they are speaking, the voice of said lecturer becomes louder and more prominent than the other sounds since the lecturer is the person being looked at in the 3D VR environment. In such an embodiment, audio and video features of said virtual conference environment are dynamically adjusted based on head position information to correspond to such a certain situation accordingly.

In a nutshell, disclosed invention relates to a virtual/augmented reality-specific tactile feedback utility that greatly enhances user immersion as well as facilitating means of control and monitoring. In contrast to the existing solutions concerning the facility of various sports such as hockey, tennis, football etc., disclosed invention provides a novel tactile stimulation unit, namely the multiple mechanical stimulation unit (MMSU) that is tasked with accurate modelling of physiological affects relating to the nature of the physical activity, comprising at least one mechanical stimulator. Disclosed invention further provides for the integration of said MMSUs to the body with the aid of flexible straps capable of housing at least one such MMSU, enabling the utility of said MMSUs in various parts of the body. Disclosed invention also teaches a biopotential recording/monitoring system that comprises a variety of sensors/receivers that are positioned in many parts of the body with the aid of flexible straps, and are able to record and collect data such as EMG, ECG, SpO2 and respiratory rate.

In various embodiments of the disclosed invention, three distinct categories for objects are established to differentiate between features comprised by said embodiments. Said three categories are respectively real objects, virtual objects and auxiliary objects. For the majority of activities a multiplicity of different objects from said categories are comprised together to achieve a desired result. Said category of real objects itself has three sub-categories, namely limb, body parts and haptic device whereby actual physical aspects of said features were used to differentiate between applications. Said categories of virtual objects and auxiliary objects both have four sub-categories: limb, a first object, a second object and a third object; and ECG, EMG, audio and video respectively.

According to an embodiment, an American football virtual environment is proposed wherein real limbs and haptic device(s) are comprised, as real objects. Said American football virtual environment comprises a hand-worn apparatus (37). In games where a ball is held by hand (e.g. basketball, American football, baseball) as well as in menial tasks where flexible material need to be examined manually, it is crucial to know several properties. Such properties may be: Amount of pressure exerted on the ball by the holding hand, flexibility of the ball and its impact information. For such applications, an embodiment is disclosed where six haptic units (30) and flexible straps extending five of said haptic units in the form of mechanical stimulation units along the fingers are comprised, defining stimulation unit regions (39) where said haptic units may be established, whereby individual stimulation of the fingers for the realistic modelling of the gripping motion exerted on the ball is achieved. Flexible straps (38) are also individually adjustable for each finger in length according to ball stiffness and grip tightness. In other embodiments, flexibility of said straps may be different for the required application, and said apparatus (37) may be configured such that it faces and covers either side of the hand. For sports such as baseball where the ball is relatively small, additional haptic units may be added to the fingertips to increase grip sensation and ball impact sensitivity.

According to an embodiment, a tennis game virtual environment is proposed wherein real limbs and haptic device(s) are comprised, as real objects. Said tennis game virtual environment comprises a virtual representation of a limb, a virtual ball and a virtual racket as virtual objects. Said tennis game virtual environment comprises ECG and EMG feedback utilities as auxiliaries.

According to an embodiment, a table tennis game virtual environment is proposed wherein real limbs are involved and haptic device(s) are comprised, as real objects. Said table tennis game virtual environment comprises a virtual representation of a limb, a virtual ball and a virtual racket as virtual objects. Said table tennis game virtual environment comprises ECG and EMG feedback utilities as auxiliaries.

According to an embodiment, a baseball game virtual environment is proposed wherein real limbs are involved and haptic device(s) are comprised, as real objects. Said baseball game virtual environment comprises a virtual representation of a limb, a virtual ball and a virtual bat as virtual objects. Said baseball game virtual environment comprises ECG and EMG feedback utilities as auxiliaries.

According to an embodiment, a golf game virtual environment is proposed wherein real limbs are involved and haptic device(s) are comprised, as real objects. Said golf game virtual environment comprises a virtual representation of a limb, a virtual ball and a virtual golf club as virtual objects. Said golf game virtual environment comprises ECG and EMG feedback utilities as auxiliaries.

According to an embodiment, a boxing, kickboxing and/or full contact martial arts virtual environment is proposed wherein real limbs/body parts are involved and haptic device(s) are comprised, as real objects. Said martial arts virtual environment comprises a virtual representation of a limb, one other limb and a body part as virtual objects. Said martial arts virtual environment comprises ECG and EMG feedback utilities as auxiliaries.

According to an embodiment, a weaponized martial arts virtual environment is proposed wherein real limbs/body parts are involved and haptic device(s) are comprised, as real objects. Said martial arts virtual environment comprises a virtual representation of a weapon (stick, sword, wand etc) and a body part as virtual objects. Said weaponized martial arts virtual environment comprises ECG and EMG feedback utilities as auxiliaries.

According to an embodiment, an archery virtual environment is proposed wherein real limbs are involved and haptic device(s) are comprised, as real objects. Said archery virtual environment comprises a virtual representation of a bow, an arrow and target as virtual objects.

According to an embodiment, a shooting (i.e. firearms) virtual environment is proposed wherein real limbs are involved and haptic device(s) are comprised, as real objects. Said shooting virtual environment comprises a virtual representation of a weapon (handgun, rifle, grenade), bullets and multiple body parts as virtual objects. Said shooting virtual environment comprises ECG and EMG feedback utilities as auxiliaries.

According to an embodiment, a dancing virtual environment is proposed wherein haptic device(s) are comprised as real objects.

According to an embodiment, a walking/running virtual environment is proposed wherein haptic device(s) are comprised as real objects.

According to an embodiment, a meditation virtual environment is proposed wherein haptic device(s) are comprised as real objects.

According to an embodiment, a driving/cycling/bikeriding virtual environment is proposed wherein haptic device(s) are comprised as real objects. Said driving/cycling/bikeriding virtual environment comprises ECG feedback utility as auxiliaries.

According to an embodiment, a penile stimulation-based sexual gratification virtual environment is proposed wherein limbs/body parts are involved and haptic device(s) are comprised as real objects. Said sexual gratification virtual environment comprises ECG and EMG feedback utilities as auxiliaries.

According to an embodiment, a vaginal stimulation-based sexual gratification virtual environment is proposed wherein limbs/body parts are involved and haptic device(s) are comprised as real objects. Said sexual gratification virtual environment comprises ECG and EMG feedback utilities as auxiliaries.

According to an embodiment, a medical procedure/surgery/injection virtual environment is proposed wherein limbs/body parts are involved and haptic device(s) are comprised as real objects. Said medical procedure environment comprises a virtual representation of a limb, a body part and an object (scalpel, needle, beam etc.) as virtual objects. Said medical procedure virtual environment comprises ECG and EMG feedback utilities as auxiliaries. According to said embodiment, a possible incision may be encoded with one motor of said haptic device (MMSU) whereby the haptic intensity increases with the speed of incision; arterial damage may be encoded with one other motor of said haptic device (MMSU). ECG and EMG auxiliary feedback utilities may serve as data sources for the environment since increased heart rate and contracted muscles are indicators of stress, which may imply fatigue. In a parallel embodiment for an injection setting; needle insertion, needle progress and delivery of medicament may be modelled by different motors in said haptic device (MMSU).

According to an embodiment, a medical palpation virtual environment is proposed wherein limbs/body parts are involved and haptic device(s) are comprised as real objects. Said medical palpation environment comprises a virtual representation of a limb, a body part and an object (scalpel, needle, beam etc.) as virtual objects. Said medical palpation virtual environment comprises ECG and EMG feedback utilities as auxiliaries. In such an embodiment, a physician manually surveys a tissue of interest (i.e. liver, kidney, masses in mammary and pancreatic tissue) for malignities or malformations via applying pressure to the target area. Physical properties of said tissues of interest may be modeled by said haptic device (MMSU).

According to an embodiment, a meeting/social activity virtual environment is proposed wherein haptic device(s) are comprised as real objects.

According to an embodiment, a touchpad-based device interactivity virtual environment is proposed wherein haptic device(s) are comprised as real objects. Said haptic device may model parameters such as touch velocity of a finger or pen, contact area etc.

All embodiments of virtual environments comprise audio and video content features as auxiliaries.

1. An enhanced tactile information delivery system suitable for artificial and virtual reality applications of physical activities, comprising:
at least one processor,
one data retention means, preferably a virtual activity apparatus; and
at least one multiple mechanical stimulation unit comprising at least one mechanical simulator preferably positioned on certain predetermined locations on a user's body with flexible straps, and/or structurally on the virtual activity apparatus, whereby mechanical responses are created and delivered thereto;
wherein the at least one processor is configured to arrange the at least one multiple mechanical stimulation unit comprising at least one mechanical stimulator to generate various multiple haptic warnings and/or stimuli, whereby a multiplicity of spatially and temporally different warnings are created.

2. The enhanced tactile information delivery system according to claim 1, wherein the virtual activity apparatus is an actively hand-held virtual object modeled after a group of real objects comprising a bat, a golf club, a melee weapon, a racket, a bow, an arrow, a firearm, a scalpel, or a hand-worn object such as a glove.

3. The enhanced tactile information delivery system according to claim 1, wherein the virtual activity apparatus in form of a hand-held virtual object comprises at least one multiple mechanical stimulation unit configured to simulate a mechanical outcome of a collision/contact with another object.

4. The enhanced tactile information delivery system according to claim 1, wherein the virtual activity apparatus in form of a hand-worn object such as a glove comprises at least one multiple mechanical stimulation unit configured to simulate a mechanical outcome of a grip type motion for simulating games sports such as basketball and baseball.

5. The enhanced tactile information delivery system according to claim 1, wherein the virtual activity apparatus in form of a hand-worn object comprises five multiple mechanical stimulation units.

6. The enhanced tactile information delivery system according to claim 1, wherein the virtual activity apparatus in form of a hand-worn object comprises six multiple mechanical stimulation units, one arranged for the palm region and five extendably arranged for fingers via flexible straps.

7. The enhanced tactile information delivery system according to claim 1, wherein the virtual activity apparatus is modeled after the reproductory part of an opposing sex whereby sexual gratification is achieved.

8. The enhanced tactile information delivery system according to claim 7, wherein the virtual activity apparatus in form of an opposing-sex reproductory part comprises at least one multiple mechanical stimulation unit configured to simulate a mechanical outcome of a pleasurable act.

9. The enhanced tactile information delivery system according to claim 1, wherein the virtual activity apparatus is a passive object modeled after a group of real objects comprising a bullet or a target.

10. The enhanced tactile information delivery system according to claim 1, further comprises at least one biopotential recording unit further comprising at least one sensor specialized for physiological parameters selected from a group of electrocardiogram, electromyogram, and oxygen saturation level and precipitation meter, whereby control/feedback of the tactile information delivery system is facilitated via the use of data recorded by the biopotential recording unit and stored in the data retention means.

11. An enhanced tactile information delivery apparatus attachable to device surfaces such as mobile phones, the enhanced tactile information delivery apparatus comprises:
at least two multiple mechanical stimulation units configured to stimulate the surface in different intensities and frequencies, whereby a gradient of haptic feedback intensity is achieved.

12. The enhanced tactile information delivery system according to claim 1, wherein the virtual activity apparatus in the form of an actively hand-held virtual object modeled after a medical object such as a scalpel, is further configured to simulate a mechanical outcome of a medical/surgical event selected from a group including incision depth, tissue strength, tissue type, vessel proximity, and nerve proximity.

13. The enhanced tactile information delivery system according to claim 2, wherein the virtual activity apparatus in form of a hand-held virtual object comprises at least one multiple mechanical stimulation unit configured to simulate a mechanical outcome of a collision/contact with another object.

14. The enhanced tactile information delivery system according to claim 2, wherein the virtual activity apparatus in form of a hand-worn object such as a glove comprises at least one multiple mechanical stimulation unit configured to simulate a mechanical outcome of a grip type motion for simulating games sports such as basketball and baseball.

15. The enhanced tactile information delivery system according to claim 3, wherein the virtual activity apparatus in form of a hand-worn object such as a glove comprises at least one multiple mechanical stimulation unit configured to simulate a mechanical outcome of a grip type motion for simulating games sports such as basketball and baseball.

16. The enhanced tactile information delivery system according to claim 2, wherein the virtual activity apparatus in form of a hand-worn object comprises five multiple mechanical stimulation units.

17. The enhanced tactile information delivery system according to claim 3, wherein the virtual activity apparatus in form of a hand-worn object comprises five multiple mechanical stimulation units.

18. The enhanced tactile information delivery system according to claim 4, wherein the virtual activity apparatus in form of a hand-worn object comprises five multiple mechanical stimulation units.

19. The enhanced tactile information delivery system according to claim 2, wherein the virtual activity apparatus in form of a hand-worn object comprises six multiple mechanical stimulation units, one arranged for the palm region and five extendably arranged for fingers via flexible straps.

20. The enhanced tactile information delivery system according to claim 3, wherein the virtual activity apparatus in form of a hand-worn object comprises six multiple mechanical stimulation units, one arranged for the palm region and five extendably arranged for fingers via flexible straps.
